(19) United States
(12) Patent Application Publication
(10) Pub. No.: US 2025/0096322 A1
(43) Pub. Date: Mar. 20, 2025

(54) SODIUM THIOPHOSPHATE CATHOLYTES FOR NONAQUEOUS FLOW BATTERIES

(71) Applicant: UT-Battelle, LLC, Oak Ridge, TN (US)

(72) Inventors: Ethan C. Self, Oak Ridge, TN (US); Michelle L. Lehmann, Oak Ridge, TN (US); Ernesto Camilo Zuleta Suarez, Oak Ridge, TN (US)

(21) Appl. No.: 18/884,288

(22) Filed: Sep. 13, 2024

Related U.S. Application Data
(60) Provisional application No. 63/538,303, filed on Sep. 14, 2023.

(51) Int. Cl. H01M 10/0567; H01M 4/58; H01M 10/052; H01M 10/0569

(52) U.S. Cl. CPC H01M 10/0567; H01M 4/5825; H01M 10/052; H01M 10/0569

(57) ABSTRACT

A sodium thiophosphate composition and method of making the composition are provided. The composition includes a mixture of Na₂S, S, and a thiophosphate compound dissolved in an aprotic solvent to form a solvated complex. The solvated complex has a nominal chemical formula Na₂PₓS_{y}, in which 0.1≤x≤10 and 1≤y<30. A sodium thiophosphate catholyte for nonaqueous redox flow batteries and a nonaqueous redox flow battery including the sodium thiophosphate catholyte are also provided. The sodium thiophosphate catholyte includes the sodium thiophosphate composition.

### CROSS-REFERENCE TO RELATED APPLICATIONS

This application claims the benefit of U.S. Provisional Application No. 63/538,303, filed Sep. 14, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to catholytes for nonaqueous flow batteries, and more particularly to such catholytes that include solvated complexes.

### BACKGROUND OF THE INVENTION

Redox flow batteries (RFBs) are commonly used for large-scale energy storage within an electrical power grid. Such RFBs can be charged during periods of low demand and discharged during periods of high demand. RFBs operate by circulating electrolytes, namely a catholyte and an anolyte, through a cell stack in which chemical energy is exchanged between the electrolytes across a membrane that separates the battery cell into a catholyte side and an anolyte side. Sodium polysulfides (Na₂S_{z}, 2≤z≤8) are promising catholyte materials for nonaqueous RFBs due to their low cost and room temperature operation. A major limitation of sodium polysulfide catholytes, however, is their low solubility (<<0.1 m) in aprotic solvents when over-discharged (e.g., z<5) or over-charged (z>8). In these cases, insoluble species such as Na₂S₄ and S form, resulting in current collector passivation and declined battery performance. Therefore, a need exists for sodium-based catholytes for RFBs that exhibit high capacity and high solubility at room temperature.

### SUMMARY OF THE INVENTION

A sodium thiophosphate composition is provided. The composition includes a mixture of Na₂S, S, and a thiophosphate compound dissolved in an aprotic solvent to form a solvated complex. The solvated complex has a nominal chemical formula Na₂PₓS_{y}, in which 0.1≤x≤10, and 1≤y<30.

In specific embodiments, the solvated complex has a nominal chemical formula Na₂PₓS_{y}, in which 0.1≤x<1 and 1≤y<30.

In specific embodiments, the solvated complex has a nominal chemical formula Na₂PₓS_{y}, in which 4<x<10 and 1<y<30.

In specific embodiments, the solvated complex has one of the following nominal chemical formulas: Na₂P_{0.5}S_{7.5}, Na₂P_{10/3}S_{28/3}, Na₂P₃S₁₅, or Na₂P₁₀S₂₈.

In specific embodiments, the thiophosphate compound has the chemical formula PₐS_{b}, in which a=2 or 4, and b≤10.

In particular embodiments, the thiophosphate compound is one of P₂S₅ and P₄S₁₀.

In specific embodiments, the aprotic solvent comprises at least one of the following: glyme (dimethoxyethane), diglyme (bis(2-methoxyethyl) ether), triglyme (1,2-bis(2-methoxyethoxy) ethane), tetraglyme (bis [2-(2-methoxyethoxy)ethyl] ether), propylene carbonate, acetonitrile, tetrahydrofuran, and dioxolane.

In particular embodiments, the aprotic solvent is diglyme.

In specific embodiments, a concentration of the solvated complex in the aprotic solvent is greater than or equal to 0.5 m.

A sodium thiophosphate catholyte for a nonaqueous redox flow battery is also provided. The sodium thiophosphate catholyte has a composition according to embodiments of the disclosure.

A nonaqueous redox flow battery including a catholyte having the sodium thiophosphate composition according to embodiments of the disclosure is also provided.

A method of making a sodium thiophosphate composition is further provided. The method includes adding Na₂S, S, and a thiophosphate compound to an aprotic solvent. Na₂S, S, and the thiophosphate compound form a solvated complex in the aprotic solvent. The solvated complex has a nominal chemical formula Na₂PₓS_{y}, in which 0.1≤x≤10 and 1≤y<30.

In specific embodiments of the method, the solvated complex has a nominal chemical formula Na₂PₓS_{y}, in which 0.1≤x<1 and 1≤y<30.

In specific embodiments of the method, the solvated complex has a nominal chemical formula Na₂PₓS_{y}, in which 4<x<10 and 1≤y<30.

In specific embodiments of the method, the solvated complex has one of the following nominal chemical formulas: Na₂P_{0.5}S_{7.5}, Na₂P_{10/3}S_{28/3}, Na₂P₃S₁₅, or Na₂P₁₀S₂₈.

In specific embodiments of the method, the thiophosphate compound has the chemical formula PₐS_{b}, in which a=2 or 4, and b≤10.

In particular embodiments of the method, the thiophosphate compound is one of P₂S₅ and P₄S₁₀.

In specific embodiments of the method, the aprotic solvent comprises at least one of the following: glyme (dimethoxyethane), diglyme (bis(2-methoxyethyl) ether), triglyme (1,2-bis(2-methoxyethoxy) ethane), tetraglyme (bis [2-(2-methoxyethoxy)ethyl] ether), propylene carbonate, acetonitrile, tetrahydrofuran, and dioxolane.

In particular embodiments of the method, the aprotic solvent is diglyme.

In specific embodiments of the method, a concentration of the solvated complex in the aprotic solvent is greater than or equal to 0.5 m.

These and other features of the invention will be more fully understood and appreciated by reference to the description of the embodiments and the drawings.

### BRIEF DESCRIPTION OF THE DRAWINGS

FIG. 1 is a schematic view of a nonaqueous redox flow battery (RFB) in accordance with embodiments of the disclosure;

FIG. 2 is a graph of charge-discharge voltage profiles of a RFB cell including a catholyte having a sodium thiophosphate composition according to embodiments of the disclosure;

FIG. 3 is a graph of charge-discharge voltage profiles of a coin cell including a catholyte having a sodium thiophosphate composition according to embodiments of the disclosure;

FIG. 4 is a graph of a cyclic voltammogram of a catholyte including a sodium thiophosphate composition according to a specific embodiment of the disclosure;

FIG. 5 is a graph of a cyclic voltammogram of a catholyte including a sodium thiophosphate composition according to another specific embodiment of the disclosure;

FIG. 6 is a graph of a cyclic voltammogram of a catholyte including a sodium thiophosphate composition according to yet another specific embodiment of the disclosure; and

FIG. 7 is a graph of a cyclic voltammogram of a catholyte including a sodium thiophosphate composition according to yet another specific embodiment of the disclosure.

### DETAILED DESCRIPTION OF THE CURRENT EMBODIMENTS

As discussed herein, the current embodiments relate to a sodium thiophosphate composition, a sodium thiophosphate catholyte including the sodium thiophosphate composition, a nonaqueous redox flow battery (RFB) including the sodium thiophosphate catholyte, and a method of making the sodium thiophosphate composition. The sodium thiophosphates having the disclosed composition are potentially useful as catholytes due to their high solubility in aprotic solvents as well as their sodiation/desodiation capacity, reversibility, and/or cycling stability.

The sodium thiophosphate composition includes a mixture of sodium sulfide (Na₂S), elemental sulfur(S), and a thiophosphate compound. Each component is added to an aprotic solvent, the three components are mixed in the aprotic solvent, and the three components react to form a solvated complex that is dissolved in the aprotic solvent. While each of the components may be added separately, it should be understood that the sodium sulfide and sulfur may be partially or fully pre-combined and added to the aprotic solvent in the form of a sodium polysulfide having the general formula Na₂S_{z} wherein z is, for instance in the range of 2 to 8. The solvated complex has the following nominal chemical formula (I):

Na₂PₓS_{y} (I)

wherein 0.1≤x≤10 and 1≤y<30. The values of x and y are dependent upon the stoichiometric amounts of sulfur and the thiophosphate compound added to the mixture. In some embodiments, the solvated complex has the nominal chemical formula (I) above wherein 0.1≤x<1 and 1≤y<30. In other embodiments, the solvated complex has the nominal chemical formula (I) wherein 4<x≤10 and 1≤y<30. In certain specific embodiments, the solvated complex has one of the following formulas (II-A) through (II-D):

Na₂P_{0.5}S_{7.5} (II-A);

Na₂P_{10/3}S_{28/3} (II-B);

Na₂P₃S₁₅ (II-C); and

Na₂P₁₀S₂₈ (II-D).

The solvated complexes of formulas (I) and (II-A) through (II-D) are highly soluble in the aprotic solvent, such as having a solubility of greater than 0.5 m, optionally greater than 0.7 m.

The thiophosphate compound may have the following nominal chemical formula (III):

PₐS_{b} (III)

wherein a=2 or 4, and b≤10. In some embodiments, the thiophosphate compound is P₂S₅ or P₄S₁₀.

In various embodiments, the aprotic solvent is diglyme (bis(2-methoxyethyl) ether). In other embodiments, the aprotic solvent may be glyme (dimethoxyethane), triglyme (1,2-bis(2-methoxyethoxy) ethane), tetraglyme (bis [2-(2-methoxyethoxy)ethyl] ether), propylene carbonate, acetonitrile, tetrahydrofuran, or dioxolane. The aprotic solvent may also be any combination of two or more of these solvents. For example, the aprotic solvent may be a mixture of diglyme and acetonitrile.

A method of making the sodium thiophosphate composition includes adding and mixing the three precursors (sodium sulfide (Na₂S), elemental sulfur(S), and a thiophosphate compound such as P₂S₅) in the aprotic solvent for a period of hours, optionally for a period of days, optionally for a period of greater than one week. For example, in some cases soluble complexes may be obtained in less than 24 hours, while in others, soluble complexes are obtained days to a week later. A magnetic stirrer or milling media may be used to mix the precursors in the aprotic solvent and to ensure homogeneity of the reaction system. The solubility and final composition of the reaction product(s) is dependent upon the stoichiometry of the precursors, and some stoichiometries may yield insoluble precipitates that are not of interest for flow battery applications which generally require cycling of soluble materials. The method can be characterized by the following chemical equation, with the stoichiometry being adjusted by varying the values of p and q:

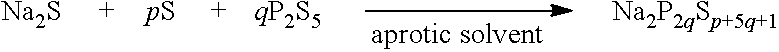

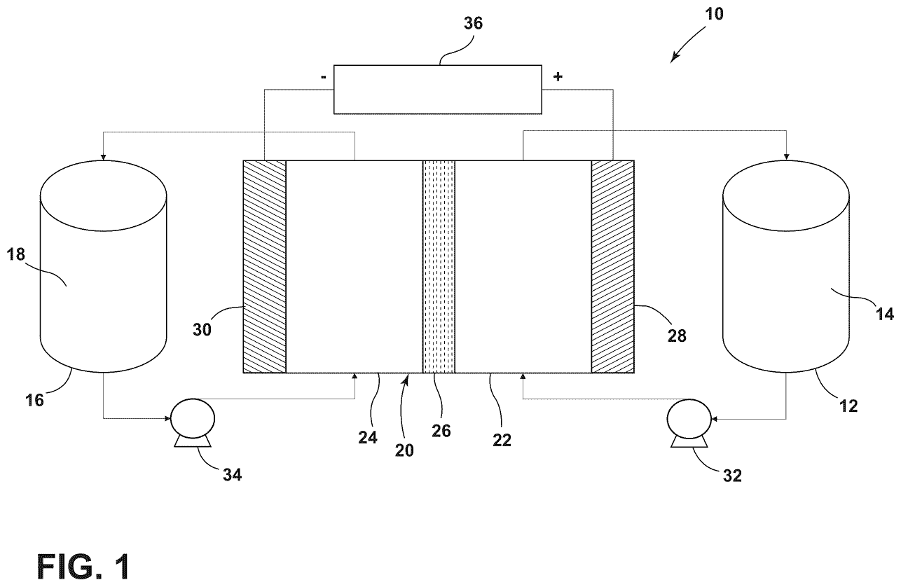

With reference to FIG. 1, a nonaqueous RFB is generally shown at 10. The RFB 10 includes a positive electrolyte reservoir 12 containing a catholyte material 14 and negative electrolyte reservoir 16 containing an anolyte material 18. The RFB 10 further includes a cell 20 including a catholyte side 22 and an anolyte side 24 separated by an ion exchange membrane 26. The positive electrolyte reservoir 12 is fluidly connected to the catholyte side 22 of the cell 20, and the negative electrolyte reservoir 16 is fluidly connected to the anolyte side 24 of the cell 20. A current collector in the form of a cathode 28 is adjacent the catholyte side 22 and a current collector in the form of an anode 30 is adjacent the anolyte side 24, such that the cathode 28 and anode 30 sandwich the catholyte side 22 and anolyte side 24. The catholyte material 14 is circulated through the catholyte side 22 to and from the positive electrolyte reservoir 12 by a pump 32, and the anolyte material 18 is circulated through the anolyte side 24 to and from the negative electrolyte reservoir 16 by a pump 34. The flow of catholyte material 14 and anolyte material 18 through the cell 20 causes a reaction in which ions are transferred between the catholyte side 22 and the anolyte side 24 through the ion exchange membrane 26 during a charging or discharging cycle. Simultaneous with the ion transfer, electrical energy flows through a power source or load (depending on whether the cell 20 is charging or discharging) designated at 36 that is electrically connected to the cathode 28 and anode 30. In various embodiments, the catholyte material 14 includes a sodium thiophosphate composition as described above. In flow battery applications, the catholyte further includes a dissolved salt, such as a dissolved sodium salt. The sodium salt may be, for example, one or more of NaPF₆, NaTFS, NaFSI, NaTFSI, NaClO₄, and NaBr. In specific embodiments, the sodium salt is either NaPF₆ or NaTFS. The RFB 10 including the catholyte material 14 is applicable to grid storage systems.

The present composition is further described in connection with the following laboratory examples, which are intended to be non-limiting.

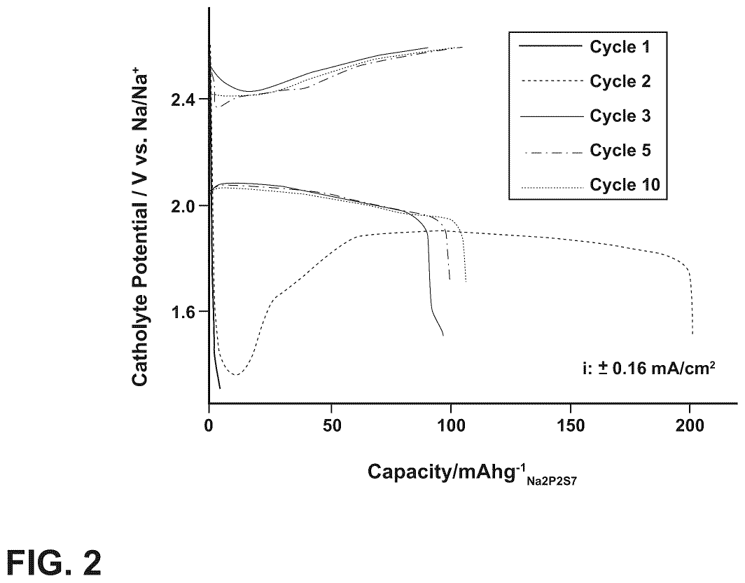

Turning to FIG. 2, a laboratory scale battery flow cell was arranged with a sodium thiophosphate catholyte in accordance with embodiments of the disclosure. The catholyte had the composition Na₂P₂S₇. A mixture of biphenyl and sodium biphenyl anion radical dissolved in supporting electrolyte was used as the anolyte, and sodium metal was used as a reference electrode. After a formation step with deep discharge in cycle 1, the flow cell with the sodium thiophosphate catholyte exhibited reversible voltage profiles in the subsequent cycles. The electrochemical equation for the catholyte half reaction is:

Na₂P₂S₇+nNa⁺+ne⁻↔Na₂₊ₙP₂S₇

wherein the specific capacity for this cell is equal to 81*n mAh/g_{Na2P2S7}.

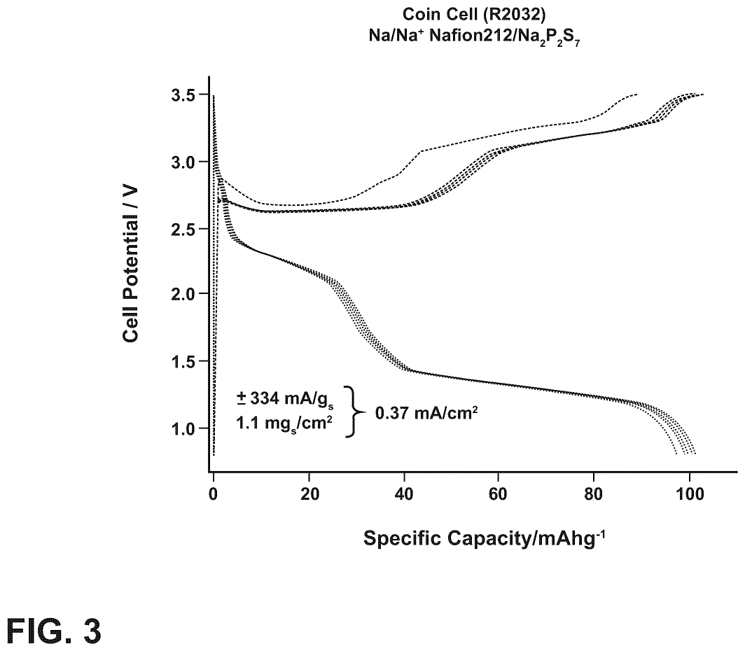

Turning next to FIG. 3, a coin cell was arranged with a sodium metal anode and a Na₂P₂S₇ catholyte separated by an ion exchange membrane. The cycling data is shown in the graph and again exhibited reversible voltage profiles which were stable upon repeated cycling.

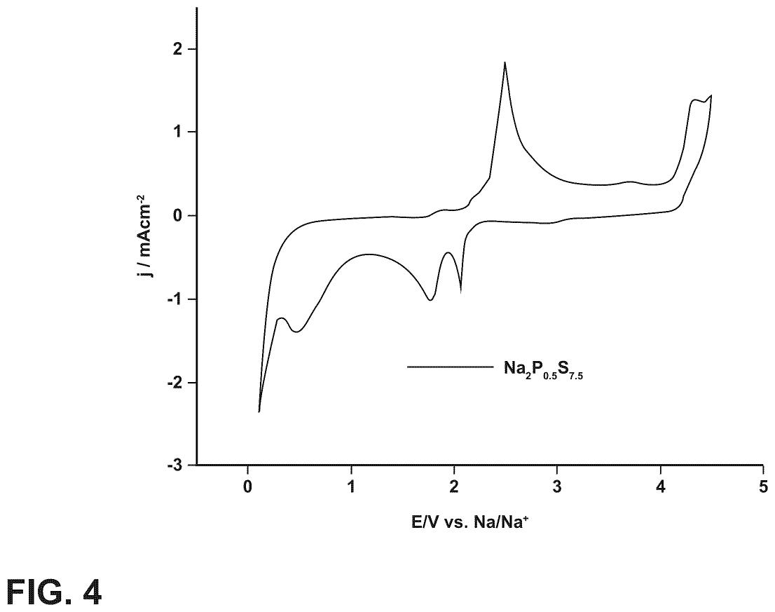

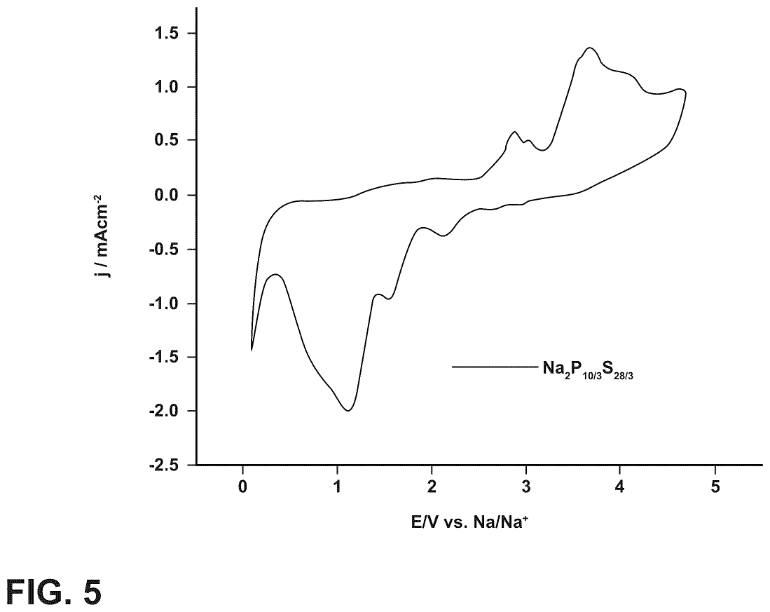

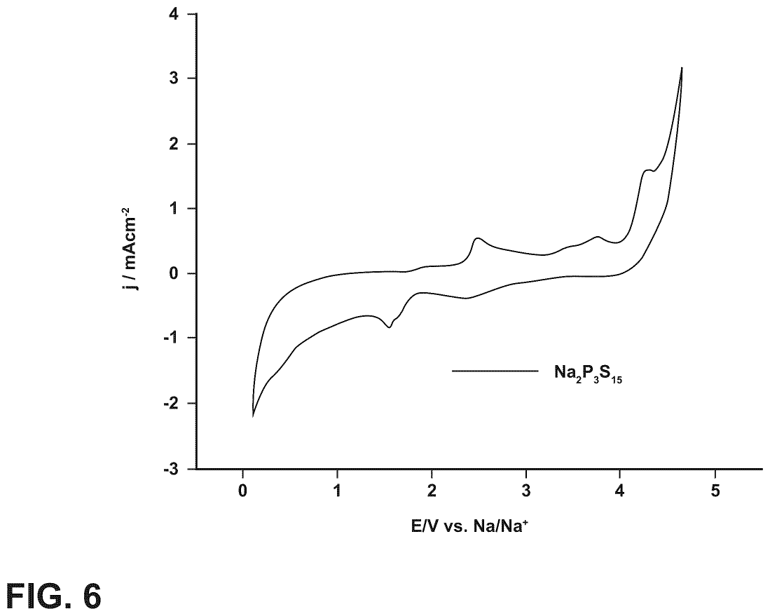

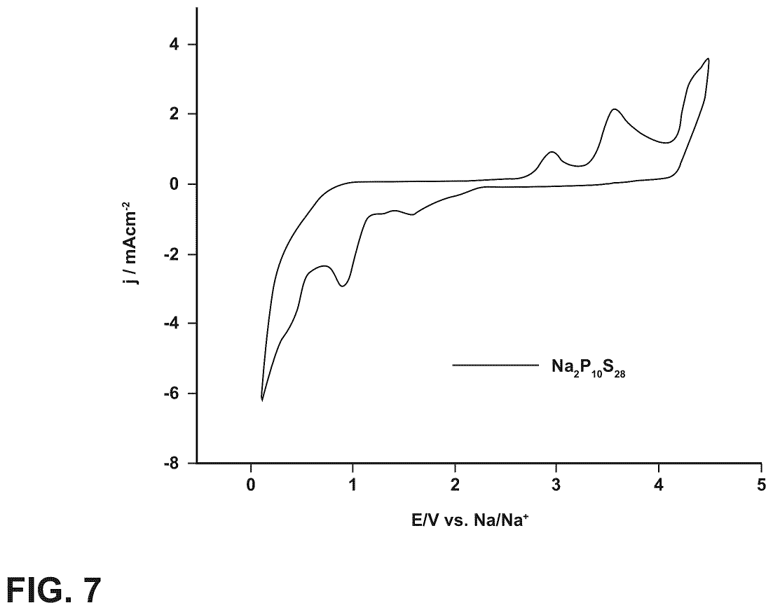

With reference now to FIGS. 4-7, specific sodium thiophosphate compositions in accordance with the disclosure were prepared. The compositions included solvated complexes dissolved in diglyme as the solvent and each had a concentration of 0.7 m. The examples are summarized in the following Table 1.

TABLE 1
Sodium Thiophosphate Compositions

| | | | Concentration of |
|---|---|---|---|
| Example | Solvated Complex | Aprotic Solvent | Solvated Complex |
| 1 | Na₂P_{0.5}S_{7.5} | Diglyme | 0.7 m |
| | [Formula (II-A)] | | |
| 2 | Na₂P_{10/3}S_{28/3} | Diglyme | 0.7 m |
| | [Formula (II-B)] | | |
| 3 | Na₂P₃S₁₅ | Diglyme | 0.7 m |
| | [Formula (II-C)] | | |
| 4 | Na₂P₁₀S₂₈ | Diglyme | 0.7 m |
| | [Formula (II-D)] | | |

Cyclic voltammograms of the sodium thiophosphate-containing catholytes according to Examples 1˜4 are shown in FIGS. 4-7, respectively. For purposes of the voltametric measurements, the catholytes had a concentration of 1-2 mM in diglyme. The anolyte was 1 M NaPF₆ in digylme. The reference electrode was Na/Na⁺. The working electrode was glassy carbon (3 mm diameter), the counter electrode was platinum (Pt) wire, and the scan rate was 50 mV/s.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A sodium thiophosphate composition comprising:
a mixture of Na₂S, S, and a thiophosphate compound dissolved in an aprotic solvent to form a solvated complex having a nominal chemical formula Na₂PₓS_{y}; wherein
0.1≤x≤10; and
1≤y<30.

2. The sodium thiophosphate composition of claim 1, wherein 0.1≤x<1.

3. The sodium thiophosphate composition of claim 1, wherein 4<x≤10.

4. The sodium thiophosphate composition of claim 1, wherein the solvated complex has one of the following nominal chemical formulas: Na₂P_{0.5}S_{7.5}, Na₂P_{10/3}S_{28/3}, Na₂P₃S₁₅, or Na₂P₁₀S₂₈.

5. The sodium thiophosphate composition of claim 1, wherein the thiophosphate compound has the chemical formula PₐS_{b}; wherein
a=2 or 4; and
b≤10.

6. The sodium thiophosphate composition of claim 5, wherein the thiophosphate compound is one of P₂S₅ and P₄S₁₀.

7. The sodium thiophosphate composition of claim 1, wherein the aprotic solvent comprises at least one of the following: glyme (dimethoxyethane), diglyme (bis(2-methoxyethyl) ether), triglyme (1,2-bis(2-methoxyethoxy) ethane), tetraglyme (bis [2-(2-methoxyethoxy)ethyl] ether), propylene carbonate, acetonitrile, tetrahydrofuran, and dioxolane.

8. The sodium thiophosphate composition of claim 7, wherein the aprotic solvent is diglyme.

9. The sodium thiophosphate composition of claim 1, wherein a concentration of the solvated complex in the aprotic solvent is greater than or equal to 0.5 m.

10. A sodium thiophosphate catholyte for a nonaqueous redox flow battery, the sodium thiophosphate catholyte comprising the composition of claim 1.

11. A nonaqueous redox flow battery including a catholyte comprising the sodium thiophosphate composition of claim 1.

12. A method of making a sodium thiophosphate composition, the method comprising:
adding Na₂S, S, and a thiophosphate compound to an aprotic solvent; wherein
Na₂S, S, and the thiophosphate compound form a solvated complex in the aprotic solvent, the solvated complex having a nominal chemical formula Na₂PₓS_{y}, in which
0.1≤x≤10; and
1≤y<30.

13. The method of claim 12, wherein 0.1≤x<1.

14. The method of claim 12, wherein 4<x≤10.

15. The method of claim 12, wherein the solvated complex has one of the following nominal chemical formulas: Na₂P_{0.5}S_{7.5}, Na₂P_{10/3}S_{28/3}, Na₂P₃S₁₅, or Na₂P₁₀S₂₈.

16. The method of claim 12, wherein the thiophosphate compound has the chemical formula PₐS_{b}; wherein
a=2 or 4; and
b≤10.

17. The method of claim 16, wherein the thiophosphate compound is one of P₂S₅ and P₄S₁₀.

18. The method of claim 12, wherein the aprotic solvent comprises at least one of the following: glyme (dimethoxyethane), diglyme (bis(2-methoxyethyl) ether), triglyme (1,2-bis(2-methoxyethoxy) ethane), tetraglyme (bis [2-(2-methoxyethoxy)ethyl] ether), propylene carbonate, acetonitrile, tetrahydrofuran, and dioxolane.

19. The method of claim 12, wherein the aprotic solvent is diglyme.

20. The method of claim 12, wherein a concentration of the solvated complex in the aprotic solvent is greater than or equal to 0.5 m.
